(19) United States
(12) Patent Application Publication
(10) Pub. No.: US 2024/0400902 A1
(43) Pub. Date: Dec. 5, 2024

(54) CROSS OVER DUCT FOR HEATING WALLS OF A COKE OVEN OR COKE OVEN BATTERY

(71) Applicant: VANOCUR REFRACTORIES LLC, TONAWANDA, NY (US)

(72) Inventors: Paul A. Saffrin, Tonawanda, NY (US); Richard M. Maida, Tonawanda, NY (US)

(21) Appl. No.: 18/701,472

(22) PCT Filed: Oct. 14, 2022
(86) PCT No.: PCT/US2022/078138

§ 371 Date: Apr. 15, 2024

Related U.S. Application Data
(60) Provisional application No. 63/262,568, filed on Oct. 15, 2021.

(51) Int. Cl. C10B 5/04; C10B 5/12; C10B 29/02

(52) U.S. Cl. CPC C10B 5/04; C10B 5/12; C10B 29/02

(57) ABSTRACT

In a coke oven having a first heating wall and a second heating wall, a cross over duct arranged to fluidly connect the first heating wall and the second heating wall. The cross over duct further comprising a passageway in communication with the first heating wall and the second heating wall.

### CROSS-REFERENCE TO RELATED APPLICATIONS

This application claims the benefit under Articles 4 and 8 of the Stockholm Act of the Paris Convention for the Protection of Industrial Property of U.S. Provisional Patent Application No. 63/262,568, filed on Oct. 15, 2021, which application is hereby incorporated by reference herein in its entirety.

### FIELD

The present invention relates to coke ovens, and more particularly, to a cross over duct that connects flues of different heating walls to regulate the temperature and exhaust gases therein.

### BACKGROUND

Coke is typically produced by heating coal in a coke oven battery. This battery may have anywhere from 40 to over 100 side-by-side coking chambers or ovens separated from each other by heating walls. Gas is burned within the walls to heat the coal arranged in the ovens. The floor bricks of each oven rest upon corbels. Below the corbels is an area called the regenerator. The regenerator is filled with bricks that have a relatively large amount of surface area per volume, generally due to slots formed in the bricks. In the regenerator, exhaust waste heat is used to pre-heat incoming air as well as cool the exhaust waste heat prior to discharge. The slotted bricks are called checker bricks, and they facilitate the heat transfer from the exhaust waste heat to the combustion materials. The regenerator supports the corbels. In turn, the corbels support the coke oven floor bricks and the heating walls. The heating walls, floor bricks, and corbels have traditionally been made of silica brick.

Coal is crushed and blended prior to being charged in a coke oven. A larry car charges the individual oven with the blended coal. In the coke oven, the coal is heated to 1,800° F. for up to 18 hours-thus the importance of the regenerator to conserve heat. During that time, the volatiles of the coal are driven into the offgas (removed), and a pure carbon form called “coke” remains.

However, current coke oven battery designs only circulate and/or vent exhaust gases within the specific flue of the heating wall. Specifically, exhaust gases are forced out of the flue, down through the corbel, and into the regenerator. Such designs do not allow for optimal air flow within the heating wall, specifically the flue, and lead to undesirable heating characteristics (i.e., loss of heat, increased fluid pressure within the flue, etc.).

Thus, there is a long felt need for a cross over duct that connects the flues of two different heating walls of a coke oven and improves air and gas flow therein.

There is another long felt need for a cross over duct that connects the flues of two different heating walls of a coke oven thereby decreasing and/or eliminating: excessive loss of heat therein; excessive fluid, and/or gas, pressure therein; and potential leak points created at seams between components of the flues-preserving the structural integrity of the flues over a longer period of time and saving potential repair costs.

There is a further long felt need for a cross over duct that connects the flues of two different heating walls of a coke oven, improves air and gas flow therein, provides for an oven ceiling of a coke oven therebelow, and at least partially provides for a portion of a coke oven battery top.

### SUMMARY

The present invention is generally arranged in a coke oven having a first heating wall and a second heating wall, where the present invention generally comprises a cross over duct arranged to fluidly connect the first heating wall and the second heating wall of the coke oven. The cross over duct may further comprise a passageway in communication with the first heating wall and the second heating wall.

In some embodiments, the present invention may generally comprise a coke oven battery, the coke oven battery including an oven floor, a first heating wall including a first flue, a second heating wall including a second flue, the second heating wall spaced apart from the first heating wall forming a coke oven therebetween, and a cross over duct, the cross over duct comprising a passageway having a passageway disposed therein, a first aperture open to the passageway, and a second aperture open to the passageway, where the first aperture is in communication with the first flue and the second aperture is in communication with the second flue. The cross over duct may further comprise a first section having a channel disposed therein, the first aperture disposed within the first section, the first aperture open to the channel and a third aperture open to the channel, and a second section having a channel disposed therein, the second aperture disposed within the second section, the second aperture open to the channel of the second section and a fourth aperture open to the channel of the second section, wherein the first channel of the first section and the second channel of the second section form the passageway.

In other embodiments, the present invention may be generally arranged in a coke oven having a first heating wall and a second heating wall, where the present invention may generally comprise a cross over duct arranged to fluidly connect the first heating wall and the second heating wall, the cross over duct comprising a first section having an external surface and an internal surface, the first section having a channel disposed therein, the channel terminated by a first aperture disposed on the internal surface and a second aperture disposed on the internal surface, and a second section having an external surface and an internal surface, the second section having a channel disposed therein, the channel terminated by a first aperture disposed on the internal surface and a second aperture disposed on the internal surface, where the channel of the first section and the channel of the second section form a passageway, the passageway in fluid communication with the first heating wall and the second heating wall.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a partial perspective view of a coke oven battery, in accordance with some embodiments of the present invention;

FIG. 2 is a partial cross-sectional view of the coke oven battery taken generally along line 2-2 in FIG. 1;

FIG. 3A generally illustrates a perspective view of the cross over duct shown in FIGS. 1 and 2;

FIG. 3B generally illustrates a skeleton perspective view of the cross over duct shown in FIG. 3A;

FIG. 4 is a cross-sectional view of the cross over duct taken generally along line 4-4 in FIG. 3A;

FIG. 5A is an exploded perspective cross-sectional view of the invention shown in FIG. 4:

FIG. 5B is an exploded side cross-sectional view of the invention shown in FIG. 4;

FIG. 6A generally illustrates a skeleton perspective view of an alternative embodiment of the present invention;

FIG. 6B generally illustrates a top skeleton view of the invention shown in FIG. 6A;

FIG. 6C is a cross-sectional view of the cross over duct taken generally along line 6C-6C in FIG. 6B; and,

FIG. 6D is a cross-sectional view of the cross over duct taken generally along line 6D-6D in FIG. 6B.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this invention pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

As used herein, “vent” is meant to mean an opening that allows fluid to pass out of or into a confined space, such as a duct. The term “fluid” includes gas.

As also used herein, “fluid communication”, “communication”, and/or substantial equivalents thereof, is meant to mean two or more components are connected such that a substance, e.g., gases, fluid, etc., can flow between and/or within the two components. “Fluid communication”, “communication”, and/or equivalents thereof, is also intend to include heat transfer between two or more components.

### Coke Oven Battery

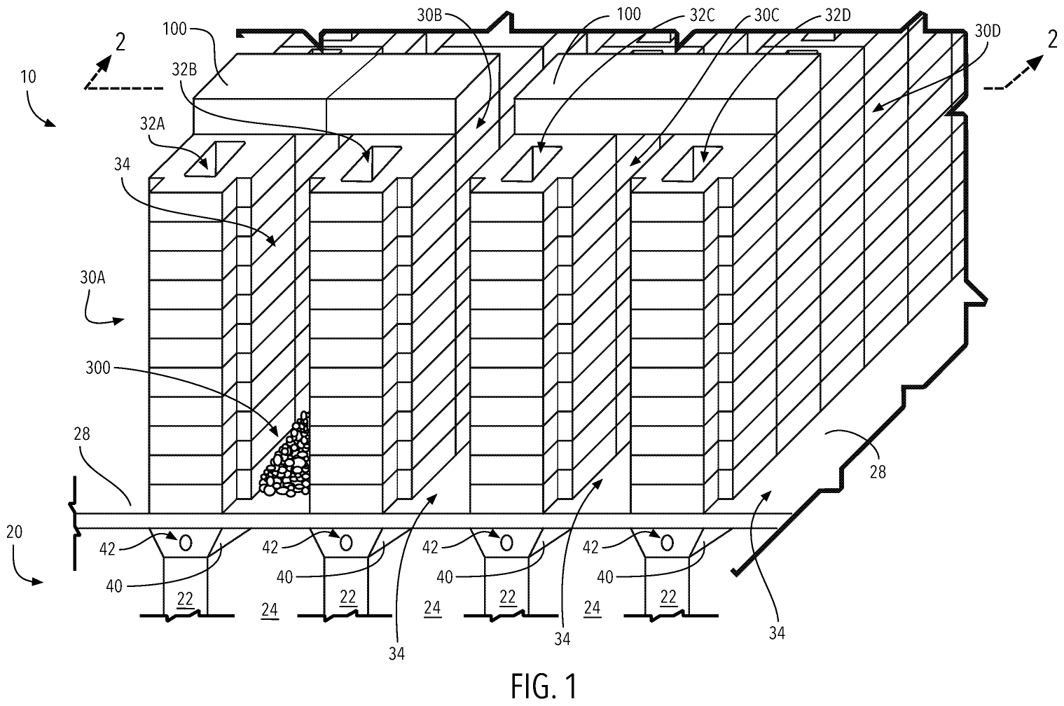

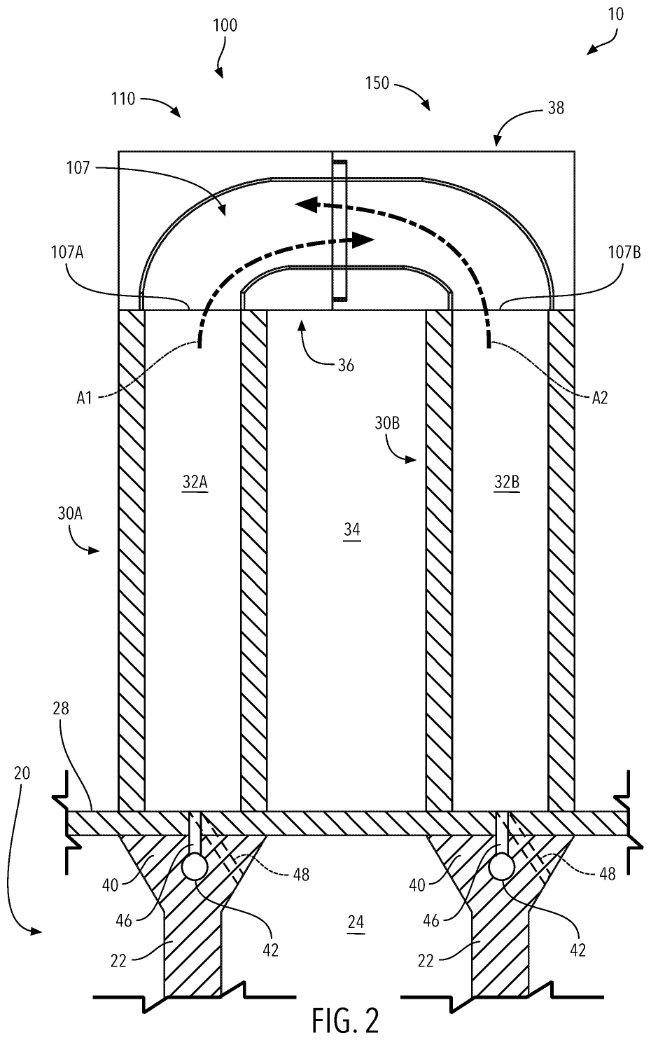

Referring now to the figures, the following description should be taken in consideration of FIGS. 1 and 2. FIG. 1 is a partial perspective view of coke oven battery 10, in accordance with some embodiments of the present invention. FIG. 2 is a partial cross-sectional view of coke oven battery 10 taken generally along line 2-2 in FIG. 1. Coke oven battery 10 generally comprises regenerator 20 and one or more ovens 34.

Regenerator 20 comprises a plurality of piers or pillars 22, which are spaced apart to form regenerator regions 24. In some embodiments, each of pillars 22 comprises a plurality of bricks or blocks. Pillars 20 support corbels 40. In some embodiments, each of corbels 40 comprises a plurality of blocks. In some embodiments, corbels 40 comprise a plurality of blocks arranged in a plurality of tiers.

Corbels 40 are arranged on top of pillars 20 and support the oven section of coke oven battery 10. Specifically, corbels 40 support floor 28, heating walls 30A-D, and coal placed in ovens 34, allow air to flow between flues 32A-D and regenerator 20, and/or allow gas to be injected into flues 32A-D. For example, gas or fuel is injected into corbels 40 horizontally via through-bore 42 and flows vertically through holes 46 and into flues 32A-D. Air flows up through holes 48 and into flues 32A-D where it mixes with the fuel and combusts to heat heating walls 30A-D, respectively, thus cooking coal 300 arranged in ovens 34 transforming it into coke (Coal 300 shown in the drawing is merely representative. In practice, the coal is crushed and blended prior to being charged in the coke oven.) Exhaust gasses are created from such combustion, these hot exhaust gases may flow down through holes 48 and into regenerator regions 24, thereby preheating the incoming gas and/or air. Preheating gas and/or air as it flows into flues prior to combustion is desirable because it produces more efficient vaporization and higher combustion efficiency than cold fuel. In some embodiments, coke oven battery 10 further comprises shut-off means (not illustrated) operatively arranged to selectively shut off the gas flow through one or more holes 42. The shut-off means (e.g., valves) allow the operator to control the temperature in each flue 32A-D and thus ovens 34. In some embodiments, and as shown, coke oven battery 10 further comprises one or more cross over ducts 100 operatively arranged to facilitate the transfer of gases between the flues of the heating walls, as will be described in greater detail, infra.

Floor 28 is arranged on and/or engaged with corbels 40. Floor 28 is operatively arranged to support coal 300 in ovens 34. In some embodiments, floor 28 comprises a plurality of blocks. In some embodiments, floor 28 comprises a plurality of blocks arranged in a plurality of tiers. Heating walls 30A-D are arranged on corbels 40 and/or floor 28 and comprise flues 32A-D arranged therein, respectively. (Heating walls 30A-D are comprised of bricks, blocks and/or modules.) Flues 32A-D are in fluid communication with holes 46 and holes 48. Oven ceiling or ceilings 36 are arranged proximate the, or on, top of heating walls 30A-D. Thus, ovens 34 are formed by floor 28, heating walls 30A-D, and oven ceiling 36. Battery top 38, or ceiling, is typically arranged on top of heating walls 30 (typically a separate component of coke oven battery, but integral with cross over duct 100, as shown in FIG. 2) and may enclose flues 32A-D. In some configurations of the present invention, cross over ducts 100 form both oven ceiling 36 and battery top 38 (as shown in FIG. 2), a significant improvement over traditional configurations of coke oven construction, as will be described in greater detail below. In some embodiments, each flue 32A-D is in fluid communication with at least one hole 46 and at least one hole 48, which thereby provides gas (via hole 46) and air (via hole 48) to that flue. The arrangement of having at least one gas injection hole 46 and an air injection hole 48 into a single flue provides a desirable combustion mixture of air and fuel.

Generally, cross over duct 100 (and cross over duct 200) provide for a transfer of gases, heat, fuel, etc., between two heating walls of coke oven battery 10—generally depicted as arrows A1 and A2, illustrating the aforementioned transfer between heating walls 30A and 30B, specifically flues 32A and 32B, i.e., cross over duct 100 fluidly connects two heating walls. It should be noted that these heating walls are typically isolated, i.e., not in fluid communication.

### Cross Over Duct

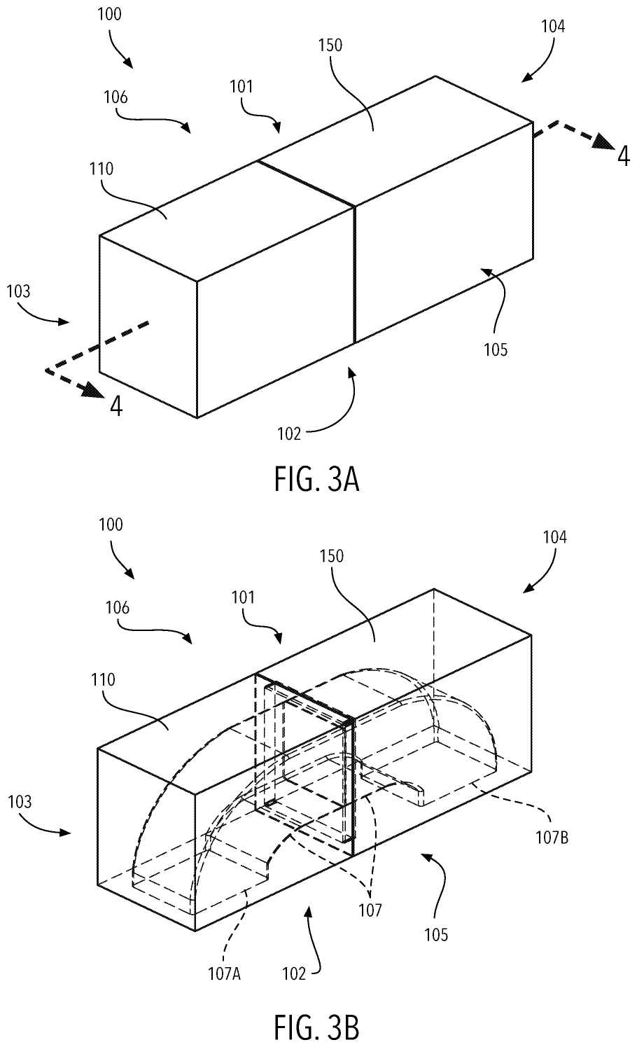

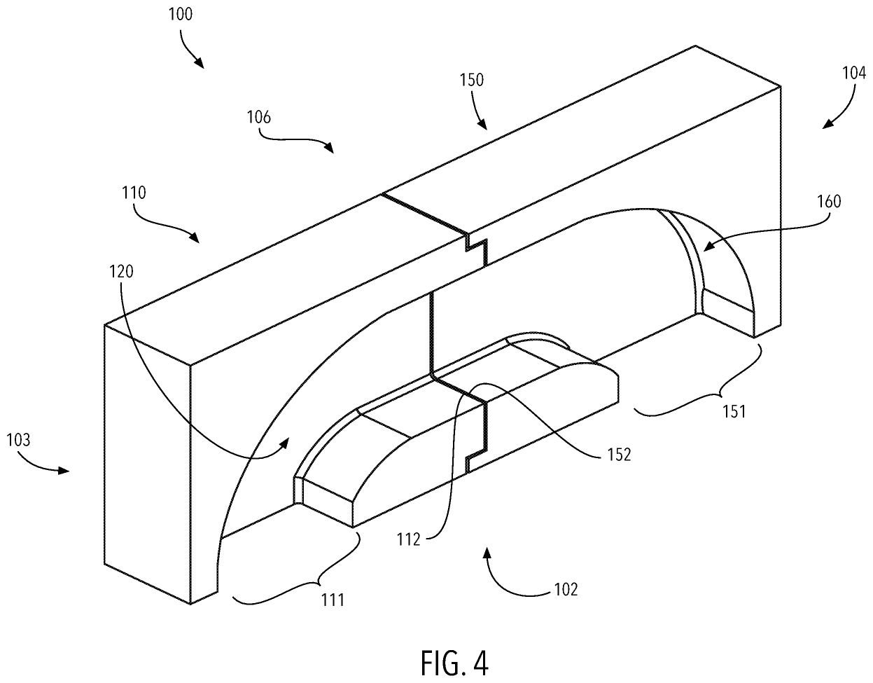

The following description should be taken in view of FIGS. 3A through 4, generally illustrating a perspective view of cross over duct 100, a skeleton perspective view of the same, and a cross-sectional view taken generally along line 4-4 in FIG. 3A. Cross over duct 100 generally includes proximal end 101, distal end 102, first end 103, second end 104, first side 105, and second side 106. Cross over duct 100 includes section 110 and section 150, shown joined, or connected, in FIG. 1. Cross over duct 100 also includes passageway 107 therein. Passageway 107 has two apertures 107A and 107B, preferably disposed on distal end 102.

Cross over duct 100 may comprise two sections, 110 and 150, which collectively form cross over duct 100. Section 110 has channel 120 therein, terminated by apertures 111 and 112. Section 150 has channel 160 therein, terminated by apertures 151 and 152. When section 110 is connected to section 150, aperture 112 of section 110 joins aperture 152 of section 150 to form a fluid connection between channel 120 and channel 160. When channel 120 and channel 160 are in fluid connection, passageway 107 is formed.

Section 110 and section 150 may be connected via any suitable means, for example, adhesives, mortar, interference or press fit, bolts, rods, etc., to form duct 100.

Although duct 100 is generally illustrated as having sections 110 and 150, collectively forming duct 100, it should be appreciated that duct 100 may be alternatively configured as a singular piece.

It should be appreciated that distal end 102 of cross over duct 100 also provides for oven ceiling 36 of oven 34 (as shown in FIG. 2). It should also be appreciated that proximal end 101 also provides for at least a section or portion of battery top 38 of coke oven battery 10 (as shown in FIG. 2). As such, cross over duct 100 at least partially provides for battery top 38 and/or oven ceiling 36—eliminating the need for additional bricks, blocks, and/or modules, during construction or repair of coke oven battery 10.

In some configurations of cross over duct 100, proximal surface 101 may include at least one aperture disposed therein, where that aperture is in fluid communication with passageway 107—providing for an inspection access to passageway 107 from proximal surface 101 (or battery top 38). In other configurations, cross over duct 100 may include at least aperture disposed within proximal surface 101 and within section 110, where that aperture is in fluid communication with channel 120—providing for an inspection access to channel 120 from proximal surface 101 (or battery top 38) within section 110 of duct 100. In further configurations, cross over duct 100 may include at least aperture disposed within proximal surface 101 and within section 150, where that aperture is in fluid communication with channel 160—providing for an inspection access to channel 160 from proximal surface 101 (or battery top 38) within section 150 of duct 100. This inspection access, or aperture, could be configured with a seal, shelf to removably accept an inspection plate, or the like, to close off the access to passageway 107, channel 110, and/or channel 150.

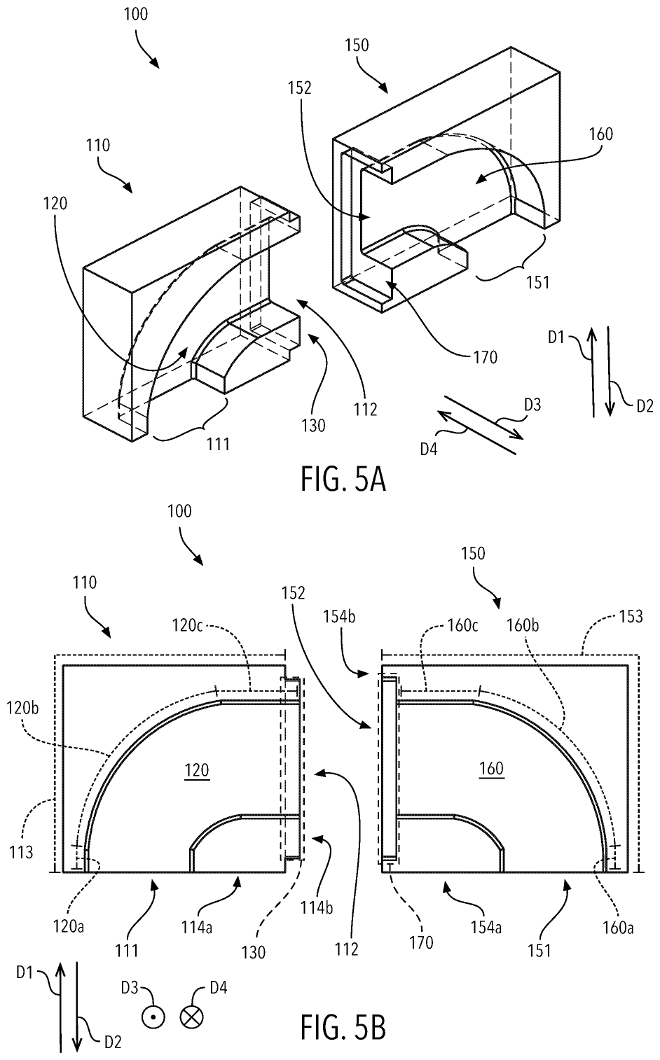

The following description should be taken in consideration of the aforementioned figures, FIG. 5A and FIG. 5B. FIG. 5A illustrates an exploded cross-sectional view of duct 100 taken generally along line 4-4 in FIG. 1 and FIG. 5B illustrates an exploded side view of the same. Section 110 of duct 100 includes external surface 113 and internal surfaces 114a and 114b. Section 150 of duct 100 includes external surface 153 and internal surfaces 154a and 154b. Aperture 111 of channel 120 is arranged within internal surface 114a and aperture 112 of channel 120 is arranged within internal surface 114a, preferably within protruding section 130. Aperture 151 of channel 160 is arranged within internal surface 154a and aperture 152 of channel 160 is arranged within internal surface 154b, preferably within recessed section 170.

Channel 120 of section 110 generally comprises three sections: distal section 120a, medial section 120b, and proximal section 120c. In some configurations, distal section 120a and proximal section 120c have a substantially linear configuration whereas medial section 120b has a substantially curvilinear configuration. Channel 160 of section 150 generally comprises three sections: distal section 160a, medial section 160b, and proximal section 160c. In some configurations, distal section 160a and proximal section 160c have a substantially linear configuration whereas medial section 160b has a substantially curvilinear configuration. This configuration of channels 120 and 150 (or passageway 107 when sections 110 and 150 are connected) is preferably to encourage efficient and proper flow of gases, heat, waste, particulate matter, or a combination thereof.

In order to create a more secure fit between section 110 and section 150, section 110 includes protruding section 130 and section 150 includes recessed section 170. When joined, combined, connection, protruding section 130 is arranged to be substantially seated, or at least partially within, recessed section 170 of section 150. This arrangement also decreases and/or eliminates excessive movement in directions D1 through D4. Additionally, this arrangement also prevents the creation of a straight joint, or seam, when sections 110 and 150 are connected—25 thereby decreasing the potential for leak points within the seam over an extended operational period.

Sections 110 and 150 may be connected via any suitable means, for example, adhesives, mortar, interference or press fit, bolts, rods, etc., to form cross over duct 100.

As best shown in FIG. 2, internal surfaces 114a and 154a of section 110 and 150, respectively, forms oven ceiling 36 and the top portion of cross over duct 100, for example, top surface 56, forms battery top 38. Thus, cross over duct 100 forms four purposes: it encloses oven 34 (by providing for oven ceiling 36 as shown in FIG. 2), it encloses flues 32A-D (flues 32C and 32D are shown in FIG. 1), it fluidly connects flues of different heating walls to allow the transfer of gas and temperature therebetween—generally illustrated by arrows A1 and A2, and it forms at least a portion of battery top 38 (as shown in FIG. 2).

### Cross Over Duct: Alternative Embodiment

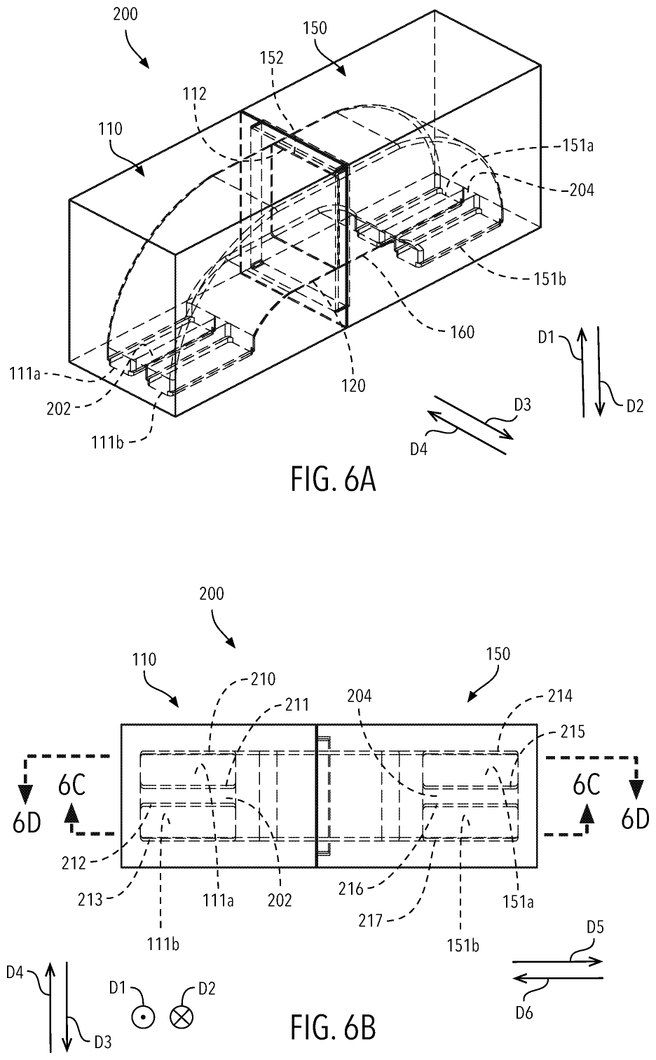

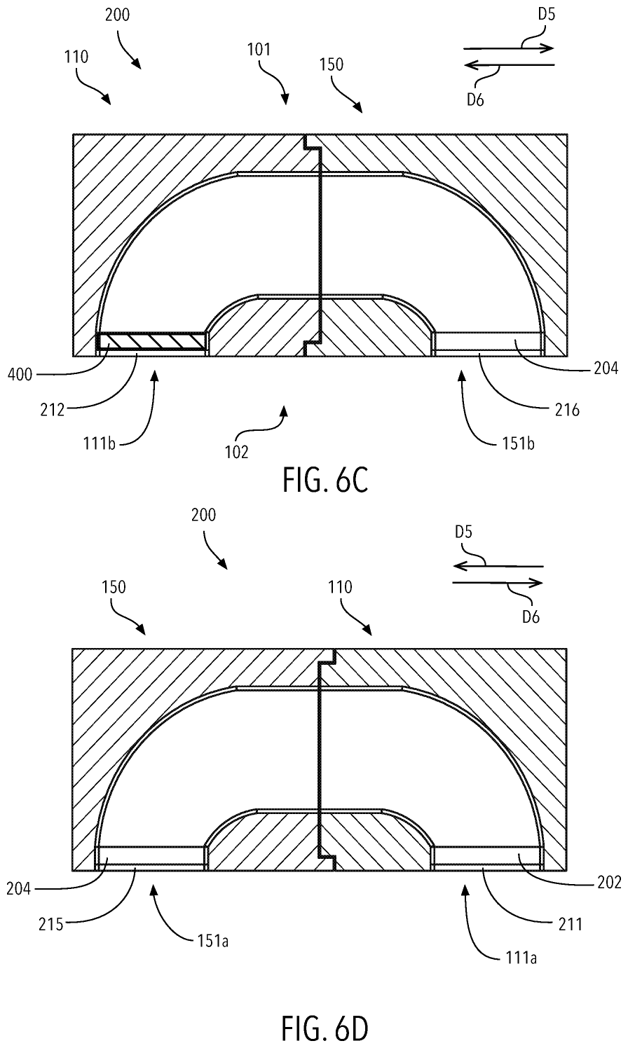

The following description should be taken in view of the aforementioned figures, FIG. 6A, FIG. 6B through 6D, where FIG. 6A generally illustrates a skeleton perspective view of an alternative embodiment of duct 100, duct 200, FIG. 6B generally illustrates a top skeleton view, FIG. 6C is a cross sectional view taken generally along line 6C-6C in FIG. 6B, and FIG. 6D is a cross sectional view taken generally along line 6D-6D in FIG. 6B.

Duct 200 includes all of the components of duct 100, with the exception of apertures 111 and 151 of sections 110 and 150, respectively. Section 110 of duct 200 includes apertures 111a and 111b, and section 150 of duct 200 includes apertures 151a and 151b. Aperture 111a and 111b are separated by bifurcating section 202 and apertures 151a and 151b are separated by bifurcating section 204. Aperture 111a includes lips 210 and 211, which extend from an internal surface of aperture 111a. Aperture 111b includes lips 212 and 213, which extend from an internal surface of aperture 111b. Aperture 151a includes lips 214 and 215, which extend from an internal surface of aperture 151a. Aperture 151b includes lips 216 and 217, which extend from an internal surface of aperture 151b. Apertures 111a and 111b are in fluid communication with channel 120 of first section 110 of duct 200. Apertures 151a and 151b are in fluid communication with channel 160 of second section 150 of duct 200. The respective pair of lips corresponding to apertures 111a, 111b, 151a and 151b, allow for a plate, brick, block to be placed thereon. As shown in FIG. 6C, plate 400 is within aperture 111b and resting on lips 212 and 213. By introducing plate 400, fluid communication between aperture 111b and channel 120 is blocked. The arrangement of the aforementioned lips (210-217), in their respective pairs, allows for customization of the gas, heat, fluid flow between sections 110 and 15 of duct 200 from the respective heating walls (illustrated in FIG. 2). As described supra, an inspection aperture may be arranged within proximal surface 101 of duct 200—thereby allowing access to plate 400.

Thus, cross over duct 200 forms three purposes: as generally illustrated by duct 100 in FIG. 2, it encloses oven 34, it encloses flues 32A-D (flues 32C and 32D are shown in FIG. 1), and it fluidly connects flues of different heating walls to allow the transfer of gas and/or temperature therebetween-substantially identical to directions illustrated by arrows A1 and A2 shown in FIG. 2 with duct 100.

It should be appreciated that the cross over duct of the present invention must be composed of a material composition that can withstand at least 1,800° F. without deformation or deterioration. It should be further appreciated that the cross over duct of the present invention is composed of a material composition that can withstand the aforementioned temperature minimum during daily operation of the coke oven battery for a minimum of 20 years.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Coke oven battery
20 Regenerator
22 Pier or pillar
24 Regenerator region
28 Floor
30A Heating wall
30B Heating wall
30C Heating wall
30D Heating wall
32A Flue
32B Flue
32C Flue
32D Flue
34 Oven
36 Oven ceiling
38 Battery top
40 Corbel
42 Through-bore
46 Hole
48 Hole
100 Cross over duct
101 Proximal end
102 Distal end
103 First end
104 Second end
105 First side
106 Second side
107 Passageway of cross over duct 100
107A Aperture of passageway 107
107B Aperture of passageway 107
110 Section
111 Aperture of section 110
111a Aperture of section 110 of duct 200
111b Aperture of section 110 of duct 200
112 Aperture of section 110
120 Channel of section 110
130 Protruding section of section 110
150 Section
151 Aperture of section 150
151a Aperture of section 150 of duct 200
151b Aperture of section 150 of duct 200
152 Aperture of section 150
160 Channel of section 150
170 Recessed section of section 150
200 Cross over duct
202 Bifurcating section of section 110 of duct 200
204 Bifurcating section of section 150 of duct 200
210 Lip of aperture 111a
211 Lip of aperture 111a
212 Lip of aperture 111b
213 Lip of aperture 111b
214 Lip of aperture 151a
215 Lip of aperture 151a
216 Lip of aperture 151b
217 Lip of aperture 151b
300 Coal
400 Plate
A1 Arrow
A2 Arrow
D1 Direction
D2 Direction
D3 Direction
D4 Direction

What is claimed is:

1. In a coke oven having a first heating wall and a second heating wall, a cross over duct arranged to fluidly connect said first heating wall and said second heating wall.

2. The cross over duct recited in claim 1 further comprising a passageway, said passageway in communication with said first heating wall and said second heating wall.

3. The cross over duct recited in claim 2 further comprising a first section and a second section, said first section having a channel therein, said second section having a channel therein, wherein said channel of said first section and said channel of said second section form said passageway.

4. The cross over duct recited in claim 3, wherein said first section includes a first aperture and a second aperture, said first aperture and said second aperture open to said channel of said first section, and, said second section includes a first aperture and a second aperture, said first aperture and said second aperture open to said channel of said second section.

5. The cross over duct recited in claim 4, wherein said first aperture of said first section is in communication with said first heating wall, said first aperture of said second section is in communication with said second heating wall, said second aperture of said first section is in communication with said second aperture of said second section.

6. The cross over duct recited in claim 4 further comprising:
a protruding section extending from said first section, said second aperture of said first section disposed within said protruding section; and,
a recessed section within said second section, said second aperture of said second section disposed within said recessed section,
wherein said protruding section of said first section is arranged to be at least partially seated within said recessed section of said second section, thereby fluidly connecting said channel of said first section and said channel of said second section.

7. The cross over duct recited in claim 6, wherein said first aperture of said first section is in communication with said first heating wall, said first aperture of said second section is in communication with said second heating wall.

8. The cross over duct recited in claim 2 further comprising a first aperture open to said passageway and a second aperture open to said passageway, wherein said first aperture is in communication with said first heating wall and said second aperture is in communication with said second heating wall.

9. A coke oven battery, comprising:
an oven floor;
a first heating wall including a first flue;
a second heating wall including a second flue, said second heating wall spaced apart from said first heating wall forming a coke oven therebetween; and,
a cross over duct, including:
a passageway disposed therein;
a first aperture open to said passageway; and,
a second aperture open to said passageway,
wherein said first aperture is in communication with said first flue and said second aperture is in communication with said second flue.

10. The cross over duct recited in claim 9 further comprising:
a first section having a channel disposed therein, said first aperture disposed within said first section, said first aperture open to said channel and a third aperture open to said channel; and,
a second section having a channel disposed therein, said second aperture disposed within said second section, said second aperture open to said channel of said second section and a fourth aperture open to said channel of said second section, wherein said first channel of said first section and said second channel of said second section form said passageway.

11. The cross over duct recited in claim 10, wherein said third aperture and said fourth aperture are in communication with one another.

12. The cross over duct recited in claim 11, further comprising:
a protruding section extending from said first section, said third aperture disposed within said protruding section; and,
a recessed section within said second section, said fourth aperture disposed within said recessed section,
wherein said protruding section of said first section is arranged to be at least partially seated within said recessed section of said second section, thereby fluidly connecting said channel of said first section and said channel of said second section.

13. In a coke oven having a first heating wall and a second heating wall, a cross over duct arranged to fluidly connect said first heating wall and said second heating wall, the cross over duct, comprising:
a first section having an external surface and an internal surface, said first section having a channel disposed therein, said channel terminated by a first aperture disposed on said internal surface and a second aperture disposed on said internal surface; and,
a second section having an external surface and an internal surface, said second section having a channel disposed therein, said channel terminated by a first aperture disposed on said internal surface and a second aperture disposed on said internal surface;
wherein said channel of said first section and said channel of said section form a passageway, said passageway in fluid communication with said first heating wall and said second heating wall.

14. The cross over duct recited in claim 13, wherein said second aperture of said first section and said second aperture of said second section are in fluid communication with one another.

15. The cross over duct recited in claim 14, wherein said channel of said first section is also terminated by a third aperture, said third aperture disposed on said internal surface of said first section and is arranged proximate said first aperture; and, said channel of said section is also terminated by a third aperture, said third aperture of said second section disposed on said internal surface of said second section and is arranged proximate said first aperture of said second section.

16. The cross over duct recited in claim 15 further comprising:
a lip at least partially disposed on an internal surface of said first aperture of said first section;
a lip at least partially disposed on an internal surface of said third aperture of said first section;
a lip at least partially disposed on an internal surface of said first aperture of said second section; and,
a lip at least partially disposed on an internal surface of said third aperture of said second section, wherein at least one said aforementioned lips may accept a plate thereon.

17. The cross over duct recited in claim 13, wherein said first aperture of said first section is in fluid communication with said first heating wall and said first aperture of said second section is in fluid communication with said second heating wall.

18. The cross over duct recited in claim 15, wherein said first aperture of said first section is in fluid communication with said first heating wall, said third aperture of said first section is in fluid communication with said first heating wall, said first aperture of said second section is in fluid communication with said second heating wall, and said third aperture of said second section is in fluid communication with said second heating wall.

19. The cross over duct recited in claim 14 further comprising:
a protruding section extending from said internal surface of said first section, said second aperture of said first section disposed within said protruding section; and,
a recessed section disposed within said internal surface of said second section said second aperture of said second section disposed within said recessed section,
wherein said protruding section is arranged to be at least partially seated within said recessed section when said second aperture of said first section and said second aperture of said second section are in fluid communication.

20. The cross over duct recited in claim 13 further comprising at least one inspection aperture disposed on said external surface, said inspection aperture in fluid communication with said passageway.
